(19) United States
(12) Patent Application Publication
(10) Pub. No.: US 2026/0197714 A1
(43) Pub. Date: Jul. 9, 2026

(54) MANUFACTURER USAGE DESCRIPTION CLIENT CAPABILITIES

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Jerome HENRY, Pittsboro, NC (US); Amine CHOUKIR, Ecublens (CH)

(21) Appl. No.: 19/281,625

(22) Filed: Jul. 26, 2025

Related U.S. Application Data
(60) Provisional application No. 63/743,475, filed on Jan. 9, 2025.

(51) Int. Cl. H04W 28/18; H04W 88/08

(52) U.S. Cl. CPC H04W 28/18; H04W 88/08

(57) ABSTRACT

Embodiments of the present disclosure include techniques for secure capabilities sharing for wireless networks. A station (STA) encodes a limited access uniform resource locator (URL) into a management frame. The limited access URL provides access to a plurality of capability elements of the STA. The operation by the STA further comprises transmitting the management frame to an access point (AP) when attempting to associate with the AP. The AP negotiates parameters with the STA based on retrieving the plurality of capability elements using the limited access URL.

### CROSS-REFERENCE TO RELATED APPLICATIONS

This application claims benefit of co-pending U.S. provisional patent application Ser. No. 63/743,475 filed Jan. 9, 2025. The aforementioned related patent application is herein incorporated by reference in its entirety.

### TECHNICAL FIELD

Embodiments presented in this disclosure generally relate to computer networking. More specifically, embodiments disclosed herein relate to systems and methods for secure capabilities sharing for wireless networks.

### BACKGROUND

When a device attempts to connect to a Wi-Fi network, initial information needed to establish the connection is typically sent in the open, since the secure communication channel has not yet been established. For example, the device may need to establish various parameters with access points in the network before it can begin transferring other data. This exposes the connection process to vulnerabilities.

The present disclosure is directed at techniques that provide a technical solution to this problem.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system for secure capabilities sharing for wireless networks, according to an embodiment.

FIG. 2 illustrates a method performed by a station (STA), according to an embodiment.

FIG. 3 illustrates a method performed by a wireless networking component, according to an embodiment.

FIG. 4A illustrates a swim-lane diagram for a method of secure capabilities sharing, according to an embodiment.

FIG. 4B illustrates a swim-lane diagram for a method of secure capabilities sharing, according to another embodiment.

FIG. 4C illustrates a swim-lane diagram for a method of secure capabilities sharing, according to yet another embodiment.

FIG. 5 illustrates hardware of a special purpose computing system configured according to the above disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure relates to a wireless station that includes one or more memories and one or more processors communicatively coupled to the one or more memories, where the one or more processors are configured to, individually or collectively, perform an operation. The operation includes encoding a limited access uniform resource locator (URL) into an unencrypted management frame. The limited access URL provides access to a plurality of capability elements of a station (STA). The operation includes transmitting the unencrypted management frame to an access point (AP) when attempting to associate with the AP, where the AP negotiates parameters with the STA based on retrieving the plurality of capability elements using the limited access URL.

In one embodiment, the operation by the wireless station further includes determining a credential of an AP that is registered and configuring the limited access URL to be accessible by the AP using the credential.

In one embodiment, the STA is provisioned with an onboarding profile, and activating the onboarding profile registers the credential of the AP.

In one embodiment, the credential of the AP is an authentication token.

In one embodiment, the credential is a public internet protocol (IP) address of the AP.

In one embodiment, the credential is a public key of the AP.

In one embodiment, configuring the limited access URL to be accessible by the AP includes receiving the public key from the AP in a beacon, and encrypting the limited access URL using the public key.

In one embodiment, the limited access URL is configured to be a single-use URL.

In one embodiment, the plurality of capability elements include a first set of capability elements and a second set of capability elements, and where only a trusted AP can access the first set.

In one embodiment, the first set of capability elements is larger than the second set of capability elements.

One embodiment presented in this disclosure relates to an access point including one or more memories and one or more processors communicatively coupled to the one or more memories, where the one or more processors are configured to, individually or collectively, perform an operation including receiving a management frame from a station (STA) during an association process, the management frame comprising a limited access uniform resource locator (URL), from the limited access URL, retrieving a plurality of capability elements of the STA, and negotiating, during the association process, parameters with the STA based on the plurality of capability elements.

In one embodiment, the operation by the access point further includes generating an onboarding profile for the STA. The onboarding profile is configured to register the credential when activated. The operation further includes provisioning the onboarding profile to the STA.

In one embodiment, the credential is a public key, and where retrieving the plurality of capability elements includes decrypting the limited access URL using the public key.

In one embodiment, the operation by the access point further includes transmitting the public key to the STA in a beacon.

In one embodiment, the management frame includes a probe request or an association request.

In one embodiment, the operation by the access point further includes determining the security of the STA based on access statistics of the URL.

One embodiment presented in this disclosure relates to a non-transitory computer-readable medium storing computer-executable instructions that, when executed by at least one processor of a computer system, perform a method including receiving a management frame from a station (STA) during an association process. The management frame includes a limited access uniform resource locator (URL). From the limited access URL, the method further includes retrieving a plurality of capability elements of the ST and negotiating, during the association process, parameters with the STA based on the plurality of capability elements.

In one embodiment, the method further includes generating an onboarding profile for the STA, the onboarding profile configured to register a credential when activated, and provisioning the onboarding profile to the STA.

In one embodiment, the credential is a public key, and where retrieving the plurality of capability elements includes decrypting the limited access URL using the public key.

In one embodiment, the method further includes transmitting the public key to the STA in a beacon.

### Example Embodiments

Described herein are techniques for secure capabilities sharing for wireless networks, namely, systems and methods for capabilities sharing between a station (STA) and access point (AP) in a wireless local area network (WLAN) providing internet access. In wireless networks, such as Wi-Fi networks, the aim is to help a station (STA) preserve its privacy and avoid tracking by eavesdroppers. During the join phase, which includes probe-requests and association, a STA shares specific capability elements with the access point (AP). These elements are used in determining the optimal parameters for channel establishment but can be used to track the STA with information element fingerprinting. An eavesdropper can use fingerprinting to infiltrate the security of the STA using the capability elements that the STA communicates with the AP. For example, because only a limited number of devices may have certain capabilities, a malicious entity eavesdropping on probe requests or association requests can infer the identity of the device and correlate other private information. To obfuscate the identity of a STA, in one embodiment a limited access uniform resource locator (URL) with capabilities information of the STA is encoded into a management frame sent to the AP during the association, rather than transmitting the capability elements directly from the STA to the AP. This ensures that only authorized APs can access the capabilities information using the URL.

In one embodiment, the STA shares its capabilities with the AP (in a probe request or association request) via an information element that encodes a URL. The URL may allow the AP to access details about the capabilities in a properly structured data model. In one embodiment, the URL may be accessible via an authentication token that the AP or wireless LAN controller (WLC) has established. This authentication token can be installed as part of an onboarding profile that is pre-loaded into the STA or that the STA downloads during a first association session and uses during a subsequent session. As part of the onboarding profile installation, the STA registers the authentication token with a HyperText Transfer Protocol (HTTP) server that answers the request for the address encoded in the URL. Therefore, an eavesdropper may be blocked, because the authentication is needed for access to the URL and the token is not forgeable.

In one embodiment, the URL may only be accessible via authentication from the AP/WLC or an infrastructure dedicated service based on an infrastructure public internet protocol (IP) address of the WLAN infrastructure. The public IP address of such a service is shared by the AP with the STA during the onboarding phase, and the STA registers the allowed IP address with a HTTP server that responds to a request for the encoded capability elements.

In one embodiment, the capability elements or information elements (IEs) present at the URL are encoded with a public key broadcasted by the AP to a STA in a beacon. An advantage of this embodiment is, even if the limited access URL is found by another entity, the capability elements can only be decoded by the AP that the STA intends to share the information with. Additionally, the embodiment is advantageous in that an onboarding process is not required. However, the STA may require an out-of-band connection (e.g., 5G) with the HTTP server so that the STA can communicate the public key.

In another embodiment, the STA generates a single-use URL. The single-use URL allows access only to the first device that uses it. Thus, after an AP first accesses the URL, an eavesdropper or any other subsequent entity will fall into a 404 error and be denied access to the capability information of the STA.

In another embodiment, the STA can reduce the scope of information that it wants to share with various APs via the URL. In one variation of the embodiment, the URL is pre-generated and is associated with a particularly defined sets of capabilities. Trusted APs are configured to access a first set of capabilities, which may be a larger, more advanced, or otherwise more complete set of capability elements than a second set of smaller, more basic capabilities.

In another embodiment, data relating to the quantity or nature of instances where a particular limited access URL was accessed can be used to measure statistics. The statistics can be used to determine the extent of information sharing on the STA's capabilities, which may indicate whether the limited access URL is still a secure means for sharing the STA's capabilities. For example, the access statistics of the URL can be used to determine the security of the STA.

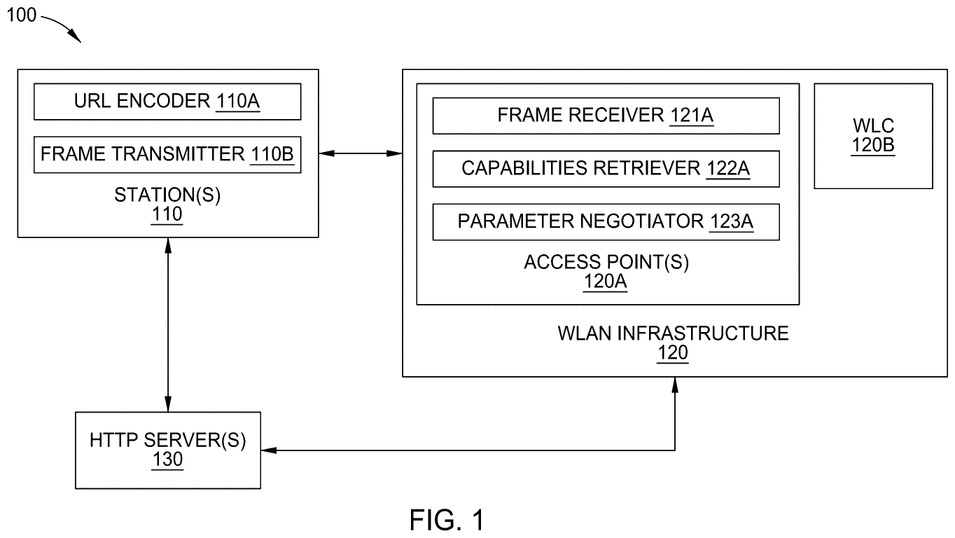

FIG. 1 illustrates a system for secure capabilities sharing for wireless networks, according to an embodiment. The system 100 includes a wireless local area network (WLAN) infrastructure 120. The WLAN infrastructure 120 components may include one or more APs 120A managed by a WLAN controller (WLC) 120B. In some embodiments, the WLAN infrastructure 120 may further provide infrastructure services, such as provisioning and onboarding. Stations (STAs) 110, such as user computers, mobile computing devices, and other client devices, are configured to communicate with the WLAN infrastructure 120.

To associate with the AP 120A, the STA 110 and AP 120A may need to negotiate parameters based on the STA's 110 capabilities. In one embodiment, a “capability” or “capability element” includes information elements that communicate a device's supported features and functionalities, including data rates, encryption support, and other information that may be used for the handshake and association process between a STA 110 (i.e., client device) and an AP 120A. In prior systems, the capability elements were typically communicated directly in unencrypted management frames between a STA and an AP, making the capabilities of the STA vulnerable to eavesdropping. Instead, a limited access URL can be encoded into the management frames which points to a hosted location where the capabilities are provided. Generally, the capabilities are used by an AP 120A to determine the STA's compatibility with the WLAN infrastructure 120, the features enabled for the session with the STA, and the security parameters that can be negotiated between the AP 120A and the STA. The capability elements may include the element ID, length, and other specifics of the underlying capability. Some non-limiting examples of capability elements include SSID, supported rates, Wi-Fi standard capability, power capability, quality of service capability, extended capabilities, etc.

In one embodiment, the capability elements are generated by the STA 110. The STA 110 can generate different sets of capabilities that can be shared with different types of entities based on trust. For example, the STA 110 can generate a larger set of capability elements which communicate advanced capabilities for trusted APs, and the STA 110 can generate a smaller set of capability elements that communicates only basic capabilities to untrusted APs. In one embodiment, the STA 110 enables a user of the STA 110 to select trusted APs 120A and configure different sets of capabilities based on trust level. The STA 110 is configured to determine which capability set to use when providing the capabilities at a limited access URL for a particular WLAN infrastructure 120. In one embodiment, the determination may be based on location. As an example, the STA 110 may be configured to use only minimal capabilities required for connection (e.g., communication bands supported) with any AP that is outside of the user's home or work network. In one embodiment, the STA 110 is configured to enable a user to register a WLAN infrastructure 120 as a trusted network with full capabilities after a first association with the WLAN infrastructure 120, so that the largest available set of capability elements can be provided in subsequent associations.

To obtain the limited access URL that will provide the capabilities to an AP 120A, the STA 110 communicates with an HTTP server 130 through a communication channel that is out of band from the WLAN infrastructure 120. For example, the communication channel between the STA 110 and HTTP server 130 may be mobile communications network (e.g., 5G). In some embodiments, to enable access by an AP 120A that the STA 110 intends to associate with, the STA 110 may provide a credential of the AP 120A to the HTTP server 130. For example, the STA 110 can register an authentication token or public IP address associated with the AP 120A or WLAN infrastructure 120. In one embodiment, the HTTP server 130 encrypts/encodes the limited access URL using a public key that the STA 110 receives from the AP 120A in a beacon, such that only the AP 120A can decrypt/decode the capability elements once retrieved. After configuring the limited access URL for access by AP 120A, the HTTP server 130 provides the limited access URL to the STA 110. The STA 110 can then provide the limited access URL in a probe request or association request to the AP 120A.

The STAs 110 include a URL encoder 110A and frame transmitter 110B. The URL encoder 110A encodes the limited access URL into a management frame for transmission to the APs 120A. The frame transmitter 110B transmits management frames comprising the encoded URL to the intended AP 120A. For example, as part of the association process, the frame transmitter 110B transmits probe requests or association requests that comprise the encoded URL.

The APs include a frame receiver 121A, frame receiver 121A, and parameter negotiator 123A. The frame receiver 121A receives the management frame in which the limited access URL is encoded and decodes the frame to extract the URL. The frame receiver 121A retrieves from the limited access URL capability elements of the STA 110. In one embodiment, retrieving the capability elements comprises decrypting the URL using the AP's public key. In another embodiment, the limited access URL is one-time use, such that the frame receiver 121A is able to retrieve the elements so long as it is the first entity to use the URL. In other embodiments, the capability retriever presents a credential of the AP 120A (e.g., public IP address or authentication token) and is able to retrieve the capabilities so long as its credential was successfully registered at the HTTP server 130 by the STA 110. Upon retrieving the capabilities at the URL, the parameter negotiator 123A uses the capabilities to negotiate parameters with the STA 110 during an association process with the STA 110.

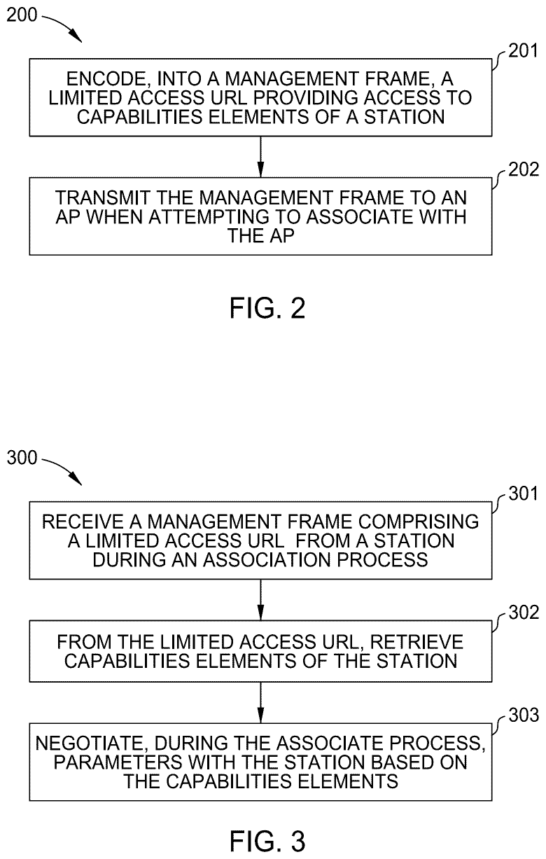

FIG. 2 illustrates a method performed by a STA, according to an embodiment. For example, the STA may be STA 110 of FIG. 1. At block 201, the STA encodes a limited access URL into a management frame. The limited access URL provides access to a plurality of capability elements of a STA. At block 201, when attempting to associate with an AP, the STA transmits the management frame to the AP. In response, the AP retrieves the capability elements using the limited access URL and negotiates parameters with the STA based on the elements retrieved.

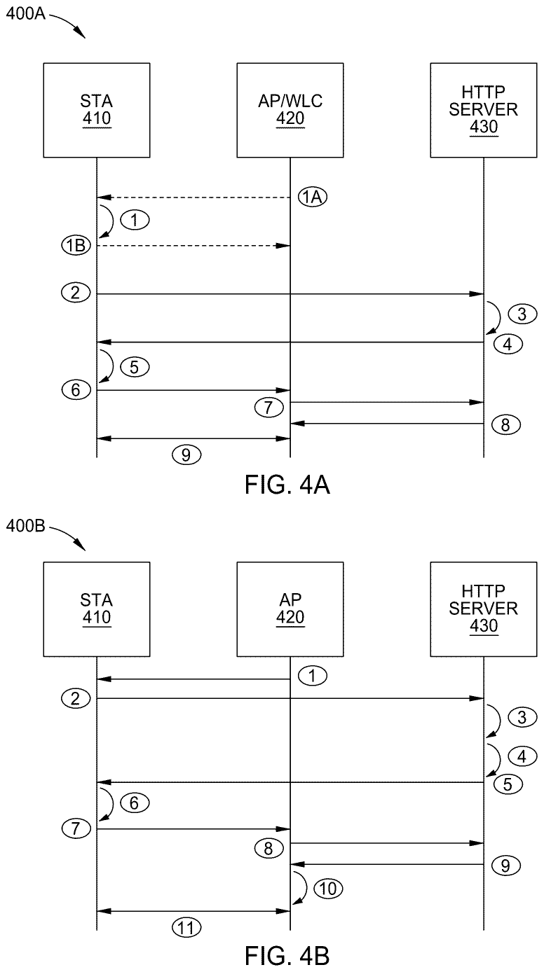

FIG. 3 illustrates a method performed by a wireless networking component, according to an embodiment. Method 300 may be performed by an access point, such as an AP 120A of FIG. 1. At block 301, the AP receives a management frame from a STA during an association process. The management frame includes a limited access URL. At block 302, from the limited access URL, the AP retrieves a plurality of capability elements of the STA. At block 303, during the association process, the AP negotiates parameters with the STA based on the capabilities.

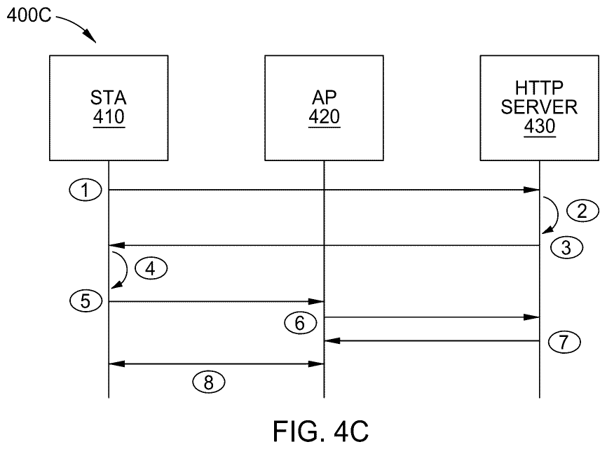

FIG. 4A illustrates a swim-lane diagram for a method of secure capabilities sharing, according to an embodiment. At the start of process 400A, the STA 410 intends to share its capabilities with an AP 420 targeted for association. At step 1, the STA 410 determines a credential of the AP 420. The credential may be an authentication token established by the AP/WLC 420 or a public IP address of the WLAN infrastructure of the AP/WLC 420.

In some embodiments, as part of performing step 1, the STA 410 may first perform step 1A. In step 1A, the STA 410 obtains the AP's credential from the AP 420. In one embodiment, the AP 420 provisions an onboarding profile onto the STA 410 through a WLAN infrastructure service. The AP's credential is installed into the STA 410 as part of the profile installation. In embodiments, the AP 420 is configured to generate an onboarding profile that triggers the STA 410 to register the AP's credential when the profile is activated. In another embodiment, at step 1A, the STA 410 obtains the credential from the AP 420 in a previous association session with the AP 420. It should be noted that, in some embodiments, step 1A is not performed because the STA may already have the AP's credential installed onto the device or may generate an authentication token on its own to give to the AP (e.g., step 1B).

In one embodiment, rather than performing step 1A, the STA 410 performs step 1B as part of step 1. In the embodiment, the STA 410 determines the AP's credential (e.g., authentication token) by generating the credential for the AP 420. Subsequently, the STA 410 performs step 1B where it provides the authentication token to the AP 420 in a first association session, so that the token can be used by the AP 420 to access the limited-access URL in a second association session.

After the AP's credential is determined by the STA 410, the STA 410 communicates with the HTTP server 430 at step 2 (e.g., as a result of activating the onboarding profile). In step 2, the STA 410 communicates the AP's credential and a set of capability elements of the STA 410 configured for access by the AP 420. The STA 410 communicates the AP's credential and capability elements over an out-of-band communication channel (e.g., 5G).

At step 3, the HTTP server 430 generates a limited access URL that is configured for access by the AP 420 and stores the capability elements at the URL. For example, the HTTP server 430 registers the AP's credential, such that the HTTP server 430 will only provide the capabilities at the URL to an entity that presents the credential.

At step 4, the HTTP server 430 provides the limited access URL to the STA 410. The STA 410 is then ready to a start a new association session with the AP 420.

At step 5, the STA 410 encodes the limited access URL into a management frame, such as a probe request or association request. For example, the management frame may comprise a dedicated information element allocated for the limited access URL.

At step 6, the STA 410 transmits the management frame to the AP 420 when attempting to associate with the AP 420. The AP 420 receives the management frame.

At step 7, the AP 420 accesses the limited access URL and presents its credential to the HTTP server 430. For example, the AP 420 may include the authentication token or public IP address in its request to the HTTP server 430.

At step 8, the AP 420 retrieves the capability elements if given access at the URL. For example, HTTP server 430 validates whether the AP's credentials were registered and provides the capabilities stored at the URL if the credential is valid.

At step 9, upon successful retrieval of the capability elements, the AP 420 negotiates parameters with the STA 410. For example, during the new association session, the available parameters are configured based on the retrieved capabilities.

FIG. 4B illustrates a swim-lane diagram for a method of secure capabilities sharing according to another embodiment. In process 400B, the AP 420 communicates with a STA 410 to enable secure sharing of the STA's capabilities with the AP 420. The STA 410 is able to provide its capability elements to the AP 420 in encrypted form by using the AP's public key as a form of credential.

At step 1, the AP 420 transmits its public key to the STA 410. In one embodiment, the AP 420 transmits the public key in one or more beacons. For example, the AP 420 can periodically broadcast the public key to STAs within radio range of the AP 420, and a STA 410 will obtain the public key if it is listening at the right point in time. In another embodiment, the AP 420 transmits the public key to the STA 410 in a previous association session.

At step 2, the STA 410 sends to an HTTP server 430 the public key and a set of capability elements that the STA 410 wants to provide to the AP 420. For example, the STA 410 sends the public key and capability elements in an out-of-band message, such as through 5G or other mobile communications channel that is outside of the WLAN infrastructure of the AP 420.

At step 3, the HTTP server 430 receives the public key and the capability elements and encrypts or encodes the capability elements using the public key. As such, only the AP 420 having the public key can decode the capability elements and discover the STA's capabilities.

At step 4, the HTTP server 430 generates a limited access URL and stores the encoded/encrypted capability elements at the URL.

At step 5, the HTTP server 430 transmits the limited access URL to the STA 410 through the out-of-band communication channel.

At step 6, the STA 410 encodes the limited access URL in a management frame, such as a probe request or association request.

At step 7, the STA 410 transmits the management frame comprising the limited access URL to the AP 420 when attempting to associate with the AP 420. The AP 420 receives the management frame.

At step 8, the AP 420 accesses the limited access URL which points to the location of the capability elements.

At step 9, the AP 420 retrieves the capability elements of the STA 410 from its stored location. The capability elements retrieved are in encrypted form or an encoded format that can only decoded using the public key.

At step 10, the AP 420 decrypts/decodes the capability elements using its public key.

At step 11, the AP 420 uses the decrypted capability elements to negotiate parameters with the STA 410 during association.

FIG. 4C illustrates a swim-lane diagram for a method of secure capabilities sharing, according to yet another embodiment. In process 400B, the capability elements are stored using a one-time use URL. As such, the first entity to access the URL will be able to retrieve the capability elements of the STA 410, and subsequent entities will receive a 404 error at the URL.

At step 1, the STA 410 requests a one-time use URL from the HTTP server 430. The request comprises capabilities of the STA 410 for storage at the URL.

At step 2, the HTTP server 430 generates the one-time use URL and stores the capabilities at the URL.

At step 3, the HTTP server 430 responds to the STA's request with the one-time use URL.

At step 4, the AP 420 encodes the one-time use URL into a management frame for association with the AP 420, such as in a probe request or association request.

At step 5, the AP 420 transmits the management frame comprising the one-time use URL. The AP 420 receives the management frame.

At step 6, the AP 420 uncovers the one-time use URL and is directed to its location.

At step 7, if the AP 420 is the first to use the one-time use URL, the HTTP server 430 responds by providing the AP 420 access to the location where the capability elements are hosted so that the AP 420 can retrieve them. Otherwise, the server returns an error to the AP 420.

At step 8, upon successful retrieval of the capability elements, the AP 420 negotiates parameters during association with the STA 410 based on the capability elements.

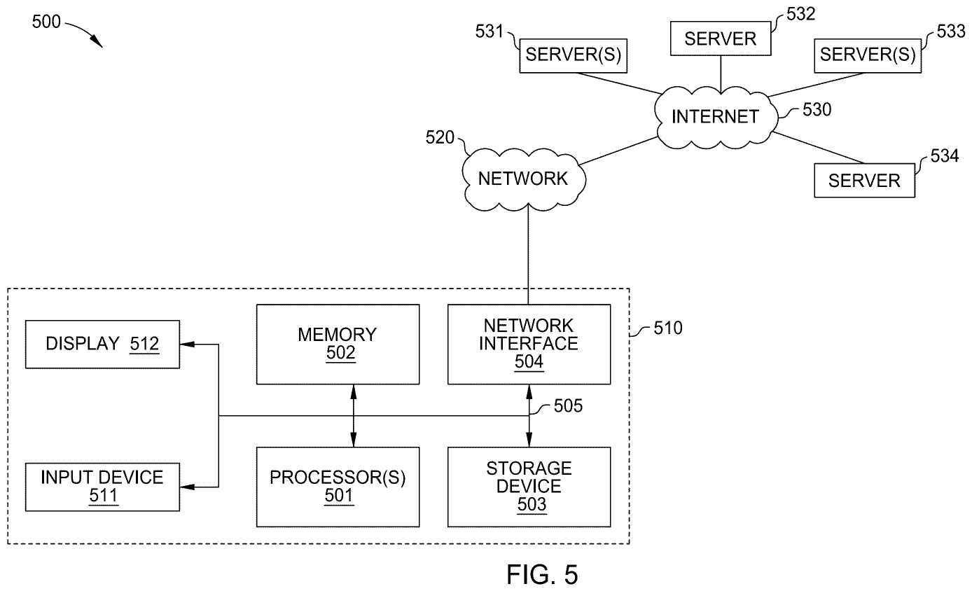

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments presented in this disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless station comprising:
one or more memories; and
one or more processors communicatively coupled to the one or more memories, wherein the one or more processors are configured to, individually or collectively, perform an operation comprising:
encoding a limited access uniform resource locator (URL) into an unencrypted management frame, the limited access URL providing access to a plurality of capability elements of a station (STA); and
transmitting the unencrypted management frame to an access point (AP) when attempting to associate with the AP, wherein the AP negotiates parameters with the STA based on retrieving the plurality of capability elements using the limited access URL.

2. The wireless station of claim 1, further comprising:
determining a credential of an AP that is registered; and
configuring the limited access URL to be accessible by the AP using the credential.

3. The wireless station of claim 2, wherein the STA is provisioned with an onboarding profile, and wherein activating the onboarding profile registers the credential of the AP.

4. The wireless station of claim 2, wherein the credential of the AP is an authentication token.

5. The wireless station of claim 2, wherein the credential is a public internet protocol (IP) address of the AP.

6. The wireless station of claim 2, wherein the credential is a public key of the AP.

7. The wireless station of claim 6, wherein configuring the limited access URL to be accessible by the AP comprises:
receiving the public key from the AP in a beacon; and
encrypting the limited access URL using the public key.

8. The wireless station of claim 1, wherein the limited access URL is configured to be a single-use URL.

9. The wireless station of claim 1, wherein the plurality of capability elements comprise a first set of capability elements and a second set of capability elements, and wherein only a trusted AP can access the first set.

10. The wireless station of claim 9, wherein the first set of capability elements is larger than the second set of capability elements.

11. An access point comprising:
one or more memories; and
one or more processors communicatively coupled to the one or more memories, wherein the one or more processors are configured to, individually or collectively, perform an operation comprising:
receiving a management frame from a station (STA) during an association process, the management frame comprising a limited access uniform resource locator (URL);
from the limited access URL, retrieving a plurality of capability elements of the STA; and
negotiating, during the association process, parameters with the STA based on the plurality of capability elements.

12. The access point of claim 11, further comprising:
generating an onboarding profile for the STA, the onboarding profile configured to register a credential when activated; and
provisioning the onboarding profile to the STA.

13. The access point of claim 12, wherein the credential is a public key, and wherein retrieving the plurality of capability elements comprises decrypting the limited access URL using the public key.

14. The access point of claim 13, further comprising transmitting the public key to the STA in a beacon.

15. The access point of claim 11, wherein the management frame comprises a probe request or an association request.

16. The access point of claim 11, further comprising determining a security of the STA based on access statistics of the URL.

17. A non-transitory computer readable medium storing computer executable instructions that, when executed by at least one processor of a computer system, perform a method comprising:
receiving a management frame from a station (STA) during an association process, the management frame comprising a limited access uniform resource locator (URL);
from the limited access URL, retrieving a plurality of capability elements of the STA; and
negotiating, during the association process, parameters with the STA based on the plurality of capability elements.

18. The non-transitory computer-readable medium of claim 17, further comprising:
generating an onboarding profile for the STA, the onboarding profile configured to register a credential when activated; and
provisioning the onboarding profile to the STA.

19. The non-transitory computer readable medium of claim 18, wherein the credential is a public key, and wherein retrieving the plurality of capability elements comprises decrypting the limited access URL using the public key.

20. The non-transitory computer readable medium of claim 19, wherein the method further comprises transmitting the public key to the STA in a beacon.
